(19) United States
(12) Patent Application Publication
(10) Pub. No.: US 2009/0012935 A1
(43) Pub. Date: Jan. 8, 2009

(54) Digital Content Delivery Systems And Methods

(76) Inventors: Gabriel B. Beged-Dov, Corvallis, OR (US); Yevgenly Eugene Shteyn, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/773,690

(22) Filed: Jul. 5, 2007

(51) Int. Cl. G06F 7/06; G06F 17/30; G06F 17/27; G06F 17/28

(52) U.S. Cl. 707/3; 707/E17.001; 707/E17.014; 715/252

(57) ABSTRACT

Digital content delivery systems and methods are disclosed in an exemplary embodiment, a method for delivering digital content may include generating an authoring list based on an order for digital content and a target playback environment for the digital content. The method may also include generating a layout based on the authoring list and at least one template. The method may also include creating an output image for the digital content.

### BACKGROUND

Digital content, including but not limited to, music, television programs, movies, and even electronic books (or “e-books”), are commercially available to consumers at media outlets, typically on compact discs (CDs) or digital versatile discs DVDs for purchase. However, these can typically only be played back on CD players or DVD players. If the consumer wants to play back music or movies on portable devices (e.g., mobile phones), the consumer must either buy the CD or DVD and load the music or movies onto their personal computer and then transfer the content to their portable device.

Digital content distribution services are also available at websites that allow users to download a wide variety of digital material over the Internet directly to their computer. The website may either charge the user a monthly access fee, or a per-use fee (e.g., similar to purchasing a CD or DVD at the store). To access the digital content, the user may logon to the website as a member, search for digital content of interest, and then stream the digital content “live” or download the digital content for later playback.

Digital content distribution services fail to provide a cost-effective and scalable way to quickly create a delivery package that comprises a set of media (e.g., music and movies) that can be consumed in a variety of consumer devices (e.g., on a computer, television, and handheld device).

### BRIEF DESCRIPTION OF THE DRAWINGS

FIG. 1 is a block diagram of an exemplary computer system which may be implemented for digital content delivery.

FIG. 2 is a schematic diagram of exemplary program code modules for implementing digital content delivery.

FIG. 3 is a high-level illustration of digital content conversion.

FIG. 4 is high-level illustration of physical media for digital content delivery.

FIG. 5 is a flowchart illustrating exemplary operations to implement digital content delivery.

### DETAILED DESCRIPTION

Briefly, systems and methods described herein may be used to implement digital content delivery systems and methods. In an exemplary embodiment, an order may specify digital content and the target playback environment for the digital content. A policy engine applies one or more policy to generate an authoring list, based on the order, and an authoring engine uses the authoring list and at least one template to generate a layout. The layout is used by a formatting engine to create an output image (e.g., on a DVD) for the digital content.

Exemplary embodiments enable fast and cost-effective creation of digital content delivery packages that can be enjoyed by the consumer on multiple platforms. Exemplary embodiments also make efficient use of the available capacity of the media, and may be implemented to generate ancillary materials that enhance the commerce opportunities associated with post-purchase transactions (e.g., cross-sell and up-sell of both local and remote products).

Furthermore, the invention provides an optimal user experience for a given media package across multiple media platforms. Things used to be simple for consumers; you go to the store, you buy a DVD, you put it into a DVD player, and it plays. Now there are all kinds of ways to experience content: DVD player, PC download, portable device and etc. All these devices allow for play-out in multiple formats, use different DRM technologies, etc. So, on one hand, the user has all kinds of opportunities with regard to playing content when she wants it in the best quality available. On the other hand, there's so much complexity in the system, that ordinary consumer simply can't take advantage of the opportunity.

Embodiments discussed herein match user personal and equipment preferences. For example, if it is known that the user has the ability to play high definition movie in compressed VC-1, rather than MPEG-2, format on her HD DVD player, then a VC-1 rendition is created and space is saved for additional items that can be put on the same disc and played, e.g. on her portable device, PC and etc. The system creates an efficient one-stop shopping destination for all user media format needs. The user doesn't have to chase various versions on iTunes, XBox-360, Amazon, NetFlix, etc. She gives information about her equipment and preferences, and the system does the rest, eliminating the need for understanding technology issues associated with format, DRM, resolution and other compatibility issues.

### Exemplary Systems

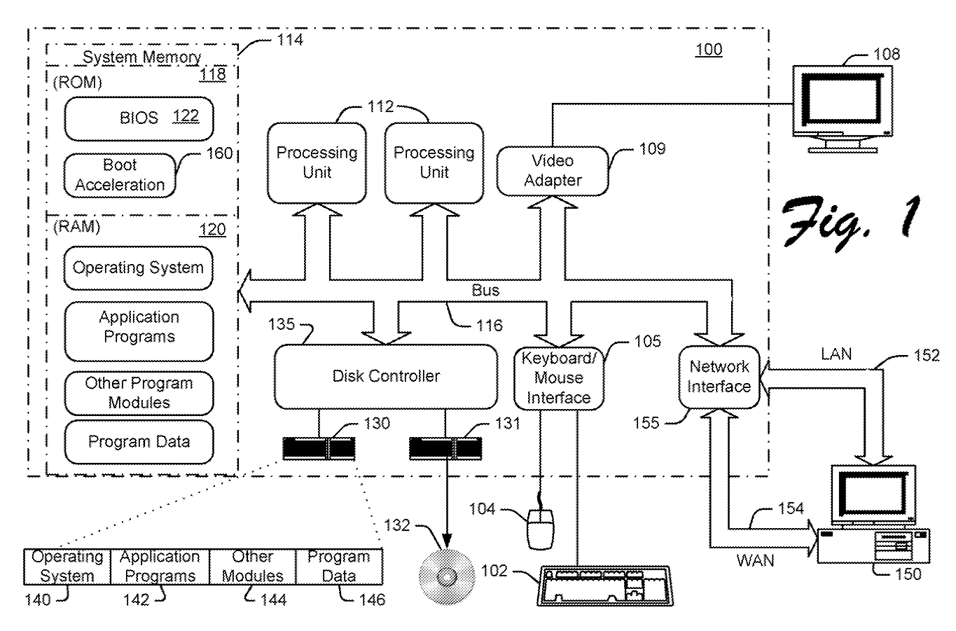

FIG. 1 is a block diagram of an exemplary computer system which may be implemented for digital content delivery. Suitable computer systems may include personal computers (PCs) or laptop computers, network workstations, appliances, or other computing devices. Exemplary computer system 100 is shown for purposes of illustration only and is not intended to be limiting.

Exemplary computer system 100 includes one or more processors or processing units 112, a system, memory 114, and a bus 116 that couples various system components including the system memory 114 to processors 112. A user may enter commands and information into computer system 100 through input devices such as a keyboard 102 and a pointing device 104. For example, the user may use these input devices to configure digital content delivery options from a user interlace (not shown). These and other input devices (not shown) are connected to the processing unit(s) 112 through an interface 105 that is coupled to the bus 116. A monitor 108 or other type of display device may also be connected to the bus 116 via an interface, such as video adapter 109.

Optionally, computer system 100 may operate in a networked environment using logical connections to one or more remote computers, such as a remote computer 150. The remote computer 150 may be a personal computer, a server computer, a router, a network PC, a peer device or other common network node, and typically includes many or all of the elements described for computer system 100. The logical connections depicted include a local area, network (LAN) 152 and a wide area network (WAN) 154 connected to the computer system 100 via a network interface 155.

In any event, bus 116 in computer system 100 represents one or more of any of several types of bus structures, including a memory bus or memory controller, a peripheral bus, an accelerated graphics port, and a processor or local bus using any of a variety of bus architectures. The system memory 114 includes read only memory (ROM) 118 and random access memory (RAM) 120. A basic input/output system (BIOS) 122, containing the basic routines that help to transfer information between elements within computer system 100, such as during start-up or reboot, is stored in ROM 118.

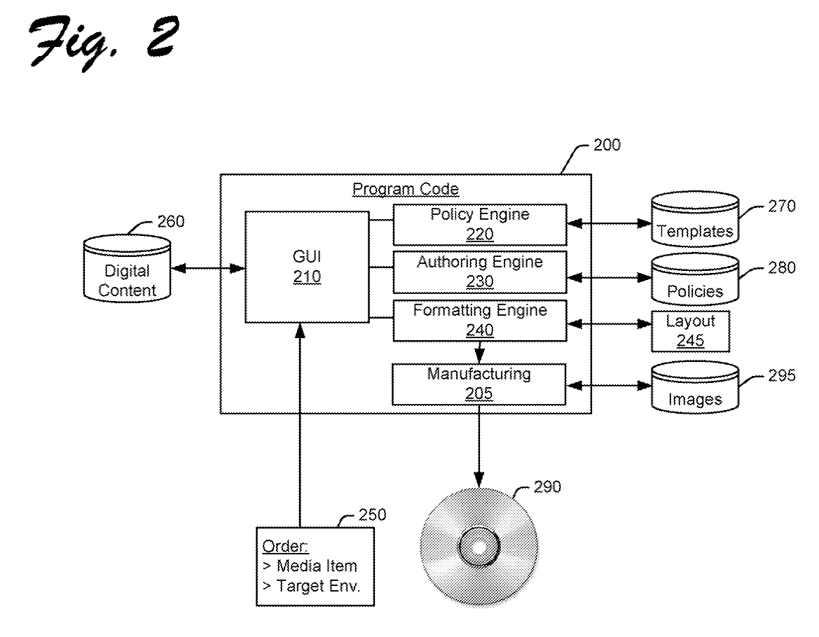

Computer system 100 further includes one or more storage device such as hard disk drive 130 for reading from and writing data. The hard disk drive 130 interfaces with various system components via the bus 116 and disk controller 135. The hard disk drive 130 and associated computer-readable media provide nonvolatile storage of computer-readable instructions, data structures, program modules and other data, for computer system 100. A number of program modules may be stored on the hard disk drive 130, including an operating system 140, one or more application programs 142 (e.g., shown in FIG. 2), other program modules 144, and program data 146.

Generally, the data processors of computer system 100 are programmed by means of instructions stored at different times in the various computer-readable storage media of the computer. Programs and operating systems may be distributed, for example, on floppy disks, CD-ROMs, or electronically, and are installed or loaded into the secondary memory of a computer. At execution, the programs are loaded at least partially into the computer's RAM 120.

Removable media, including DVDs and CDs, may also be used in the exemplary computer system 100. In exemplary embodiments, the digital content is written via disk controller 135 and drive 131 to a disc 132 (e.g., DVD or CD) for delivery, as will be explained in more detail below. Other types of removable media may include, but are not limited to, magnetic cassettes, USB drives, and flash memory cards.

These and other functional components may be used to implement digital content delivery, as better understood with reference to the figures and following description.

FIG. 2 is a schematic diagram of exemplary program code modules for implementing digital content delivery. Exemplary program code 200 may include computer-readable instructions executable by one or more computing systems (e.g., computer system 100 in FIG. 1). Optionally, program code 200 may be a web-based application executing at a network server and various functional modules may be implemented as applets or script executing at a networked computing device.

Program code 200 may be implemented as one or more functional modules. For example, these modules may include a graphical user interface (GUI) module 210, a policy engine 220, an authoring engine 230, and a formatting engine 240. In another example, software modules may be implemented as components in a Service-Oriented Architecture computing environment.

In an exemplary embodiment, the GUI module 210 is responsible for instantiation and operation of various user interfaces to receive and process an order 250. The user interfaces are created and presented to the user based on parameters such as, but not limited to, user preferences, access device configuration (e.g., screen size, bandwidth, security, and/or default settings), merchant's content catalog, promotion time window. The GUI module 210 enables the user to interact and browse a variety of digital content, place orders, specify content delivery options (e.g., download, mail, etc.), specify delivery target devices (e.g. PC, TV, mobile, etc), rate content and presentation, switch interface mode, express and store preferences, etc.

An order 250 may be processed by the program code 200. The order specifies at least the content items stored in digital content repository 260 (e.g., movie and/or music by title or other identifier) and a target device (e.g., playback oil a TV, PC, or handheld device). The digital content repository 260 stores available media items, e.g., in high-quality source assets and “renditions” in a delivery format that is more amenable to incorporation in one of the “sessions” of the delivery package. For example, a high definition rendition can be in VC-1 format, a portable one in H.264/MPEG-4 AVC, etc.

The policy engine 220 includes logic that identifies content items and applications that comprise the delivery package. The policy engine 220 also determines how to compose and layout the media, items and applications onto sessions of the delivery package For example, given information about user audio-video equipment listed in the profile, the policy engine 220 determines formats and resolutions for content items (MPEG-2, AVC, VC-1, etc) and selects applications that can be run on the equipment (JavaScript, Win32 executable code, Java applets, etc.). The applications may manage the interactive experience for each session as well as between sessions. The policy engine 220 makes use of templates 270 and (e.g. based on target devices, content relevancy information, user shopping history, community recommendations, and etc.) to determine which renditions of the media items will be needed, how those renditions will be combined, and how the applications will access them. Templates 270 may be further customized based on information from content owners (e.g., studios), merchants, other third-parties, including users, etc. In one example, a template contains rules for creating a media package for a TV series. The template determines that two most popular episodes should be provided in renditions playable on a DVD player, PC (Windows Media Player), and a portable device (Zune, by Microsoft corporation). In addition to that the template specifies that the rest of the TV series should be provided only in portable format. In another example, a template contains rules for creating a media package for an action movie. It specifies that the movie should be encoded in VC-1 for play out on ED DVD player and a PC, while trailers and selected scenes with special effects, interviews with actors, and other auxiliary materials in portable Windows Media 10 format. Alternatively, the template may specify BlueRay renditions for high definition rendition of the content, if the content is intended for play on a PlayStation device manufactured by Sony Corp.

Heuristics may include algorithms to determine auxiliary content items, based on their popularity ranking among customers within the same age group and ordering patterns as the intended content user. In another example, heuristics may include items frequently reviewed by the users' friends within her virtual social network such as www.facebook.com, www.myspace.com, www.livejournal.com, etc.

The authoring engine 230 is responsible for the execution of the selected policies on the media items as well as any metadata (e.g.. templates 270) in order to create or retrieve intermediate media assets. The intermediate media assets enable parameters to be optimized for different target playback environments. For example, for output on a portable device may be instantiated in MPEG-4 AVC (H.264) video format. In another example, applications for output on televisions may be instantiated in compliance with the Consumer Electronics Association's (CEA) R7 Home Network Committee standard, CEA-2014. In another example, the applications and media items for output on personal computers may be optimized for Microsoft Internet Explorer 7.0 or Microsoft Windows Media Player, respectively. It is also noted that the user may transfer digital content to other devices. For example, the user may access the interface using a mobile phone, gaming device, home server, etc.

In addition to that authoring engine 230 collates the media renditions, and where necessary, causes their creation. The authoring engine 230 also creates a layout plan for the media layer of the first and second sessions, and generates the application layers based on policies 280 for the first and second sessions. The layout plan provides information related to physical location, e.g. sector by sector, of content items on target physical media, such as DVD, BlueRay disc, HD DVD, memory stick, and etc. Policies may contain information about user devices (e.g., iPod® versus Windows® Media Player), preferred resolutions (mobile, standard-definition, high-definition, etc.). Policies may also identify content items and applications for the disc, as well as items that should be printed and embedded into the disc packaging or envelope (e.g., via a variable data printing process). The printed and embedded items may comprise still pictures, personal and/or professional, audio chips with, integrated LEDs, Memory Spots, or any other printable or embedded media. Users are enabled to select packaging type (e.g. photo album, gift box, audio card) and supply their own content for the envelope design (e.g. text, pictures, sounds).

The formatting engine 240 is responsible for taking the authored content, and creating the sessions as well as the final memory image. That is, the formatting engine 240 assembles the media items specified in the order 250 for delivery, e.g., on a CD or DVD 290 (or alternatively for download over a network). In operation, formatting engine 240 may use one or more template 270 to pull relevant content and applications from appropriate digital content sources (e.g., renditions, meta-data, applications, user content, etc.). The formatting engine 240 may use a layout module 245 to create a memory image. The layout module 245 can be internal or external to the formatting engine 240. The memory image may be stored for future use in images 295.

In some embodiments, a manufacturing module 205 may be implemented to receive memory images from formatting engine 240 and create one or more shipment package (e.g., disc 290), e.g., in high (or commercial) volume.

It is noted that exemplary program code 200 is shown and described herein for purposes of illustration and is not intended to be limiting. For example, the functional components shown in FIG. 2 do not need to be encapsulated as separate modules. In addition, other functional components (not shown) may also be provided and are not limited to those shown and described herein. They may be instantiated in a Business-to-Consumer, as well as Business-to-Business environments. In the latter case, module 210 may exchange information with a remote client (not shown) that would in turn generate GUI.

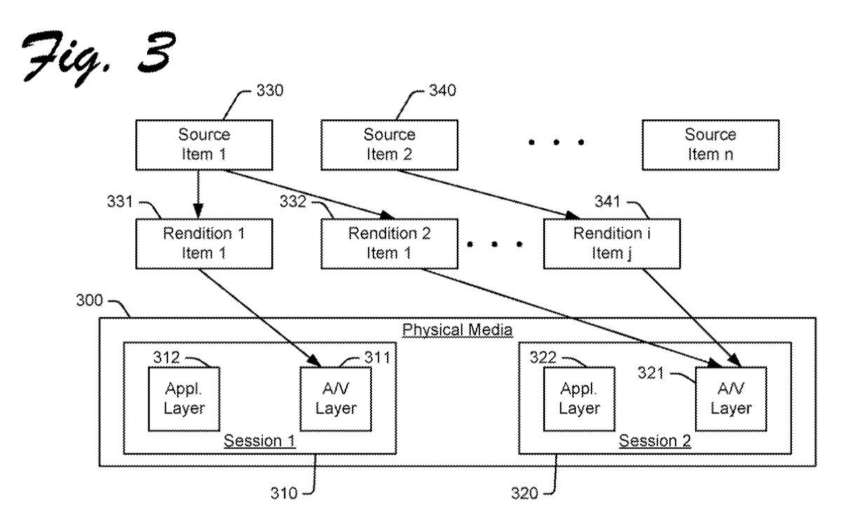

FIG. 3 is a high-level illustration of digital content conversion. In this illustration, there are two sessions on a DVD 300. In an exemplary embodiment, the first session 310 is called the DVD-Video session and contains audio/visual (A/V) layer 311 and associated interactive applications conforming to the DVD-Video specification winch allows any compliant DVD player to access the contents. The second session 320 is called the Data session and may include an arbitrary set of files laid out in conformance with the UDF file system specification in the A/V layer 321. Both sessions 310, 320 include an optional application layer 312 and 322 that allow a rich user experience to wrap the A/V files (e.g., playback menus, references to or segments of related content, etc.).

In this illustration, source item 330 is converted to two renditions 331 and 332, and source item 340 is converted to one rendition 341. Rendition 331 can be played via the DVD-Video session, and accordingly is written to the A/V/layer in the first session 310. Rendition 332 and 341 can be played in a PC environment, and accordingly is written to the A/V layer in the second session 320. Of course, the physical media 300 is not limited to only sessions 1 and 2. It may contain renditions targeted to a third device, e.g. a portable media player, a game console, etc. Renditions 331, 332, 341, may be encrypted in compliance with DRM requirements of target devices. For example, rendition 331 is produced according to Content Scramble System from DVD-CCA, while rendition 341 is produced according to FairPlay system from. Apple, Inc., or Play-For-Sure from Microsoft Corp.

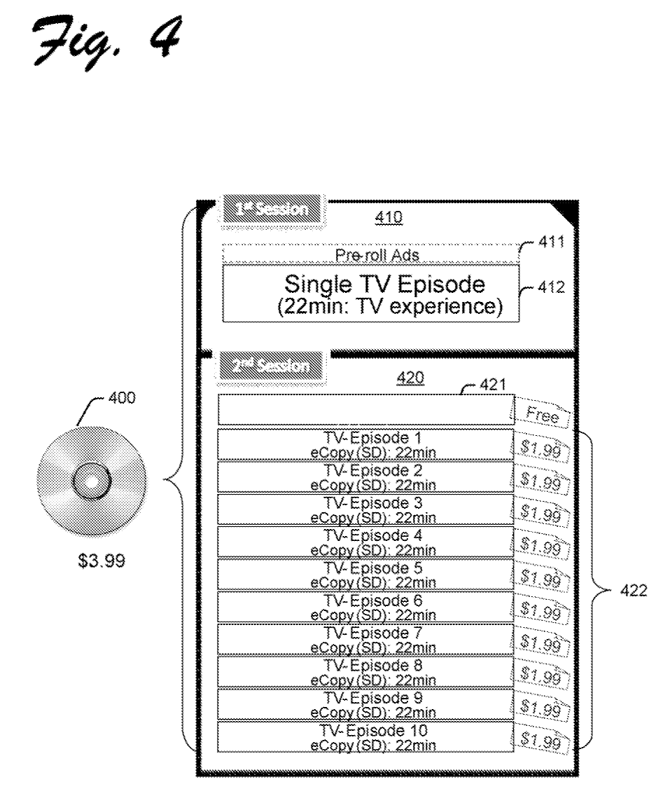

FIG. 4 is a high-level illustration of physical media for digital content delivery. The exemplary disc 400 contains materials that relate to a Session 1 Experience 410 (e.g., advertising 411 and a single TV episode 412 that the user purchased) and a Session 2 Experience 420. The Session 2 Experience 420 may include another “free” or “bonus” episode 421, and other episodes 422 that the user may wish to “unlock” by obtaining a “key”, e.g. by a purchasing it on a merchant's website, redeeming a promotional coupon, retrieving from a digital wallet, USB key fob, and etc,

Still other content (e.g., files to be downloaded to another device) and identification information (e.g., disc ID, Promotion ID, Local ID, and etc.) may be provided in the Session 2 Experience 420, or in other sessions (not shown). Other materials may include trailers, pictures, and applications (e.g., executables, scripts, games, byte code, etc.).

Optionally, an envelope (not shown) may also be printed for the disc 400 (e.g., with pictures, text, bar-code, etc.). Embedded items may also be provided (e.g., promotional stickers, audio chips, etc.).

Before continuing, it is noted that the exemplary embodiments discussed above are provided for purposes of illustration. Other system implementations are also contemplated.

### Exemplary Operations

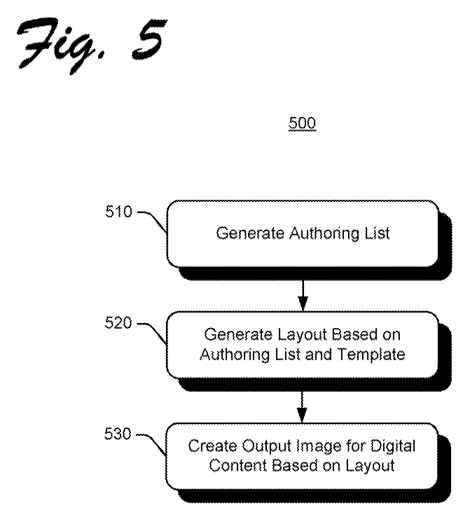

FIG. 5 is a flowchart illustrating exemplary operations 500 to implement digital content delivery. The operations may be embodied as logic instructions on one or more computer-readable media When executed on a processor, the logic instructions cause a general purpose computing device to be programmed as a special-purpose machine that implements the described operations. In an exemplary implementation, the components and connections depicted in the figures may be used to implement, digital content delivery.

In operation 510 an authoring list is generated, e.g., based on an order for digital content and a target playback environment for the digital content. In operation 520 a layout is generated based on the authoring list and at least one template. Then in operation 530 an output image is created (e.g., on a DVD) for the digital content based on the layout.

The operations shown and described herein are provided to illustrate exemplary implementations of digital content delivery and are not intended to be limiting. For example, a different sequence may be implemented than that which is shown in FIG. 5. Other operations may also vary based at least in part on design considerations.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A digital content delivery system comprising:
a policy engine applying at least one policy to generate an authoring list based on an order for digital content in a target playback environment;
an authoring engine using the authoring list from the policy engine and at least one template to generate a layout; and
a formatting engine operatively associated with the authoring engine to create an output image for the digital content.

2. The system of claim 1 wherein the order specifies the target playback environment.

3. The system of claim 1 wherein the order specifies the digital content.

4. The system of claim 1 wherein the policy engine populates the at least one policy based at least in part on user input parameters.

5. The system of claim 1 wherein the user input parameters include at least one of the following: geographical data, market, data, and user data.

6. The system of claim 1 further comprising a conversion engine for converting high-quality source assets to at least one delivery format for the digital media.

7. The system of claim 1 wherein the formatting engine creates a first session template and a second session template for writing the output image of the digital content.

8. The system of claim 1 further comprising a layout module for creating a disc image.

9. The system of claim 8 wherein the layout module is part of the formatting engine.

10. A method for delivering digital content comprising:
generations an authoring list based on an order for digital content and a target playback environment for the digital content;
generating a layout based on the authoring list and at least one template; and
creating an output image for the digital content based on the layout.

11. The method of claim 10 further comprising receiving an order specifying the digital content.

12. The method of claim 10 further comprising identifying the target playback environment.

13. The method of claim 10 further comprising applying at least one policy to create the output image for the digital content.

14. The method of claim 10 further comprising receiving high-quality source assets for the digital content for tilling the order.

15. The method of claim 14 further comprising converting the high-quality source assets to at least one delivery format for the output image.

16. The method of claim 10 further comprising creating a first session template and a second session template for creating the output image for the digital content.

17. The method of claim 10 further comprising creating a disc image.

18. A system for delivering digital content comprising:
means for generating an authoring list based on digital content and a target playback environment for the digital content;
means for using the authoring list and at least one template to generate a layout; and
means for using the layout to create an output image for the digital content.

19. The system of claim 18 further comprising means for identifying digital content and a target playback environment for the digital content.

20. The system of claim 18 further comprising means for applying at least one policy to create the output image.
